(19) United States
(12) Patent Application Publication
(10) Pub. No.: US 2025/0358870 A1
(43) Pub. Date: Nov. 20, 2025

(54) SIGNALING DESIGNS FOR MULTIPLE RADIO ACCESS NETWORK (RAN) CONNECTIVITY

(71) Applicant: QUALCOMM Incorporated, San Diego, CA (US)

(72) Inventors: Punyaslok PURKAYASTHA, San Diego, CA (US); Ozcan OZTURK, San Diego, CA (US); Gavin Bernard HORN, La Jolla, CA (US); Miguel GRIOT, La Jolla, CA (US); Kianoush HOSSEINI, San Diego, CA (US)

(21) Appl. No.: 18/665,467

(22) Filed: May 15, 2024

(51) Int. Cl. H04W 76/10; H04W 8/24; H04W 24/10

(52) U.S. Cl. CPC H04W 76/10; H04W 8/24; H04W 24/10

(57) ABSTRACT

Certain aspects of the present disclosure provide techniques for dual stack configuration and operation. A method generally includes sending one or more indications of apparatus information comprising one or more of: user equipment (UE) control plane assistance information, of the apparatus, related to a first radio access network (RAN), wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

### INTRODUCTION

Aspects of the present disclosure relate to wireless communications, and more particularly, to techniques for multiple radio access network (RAN) connectivity.

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes sending one or more indications of apparatus information comprising one or more of: user equipment (UE) control plane assistance information, of the apparatus, related to a first radio access network (RAN), wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Another aspect provides an apparatus configured for wireless communications. The apparatus includes one or more memories and one or more processors coupled to the one or more memories. The one or more processors are configured to cause the apparatus to send one or more indications of apparatus information comprising one or more of: UE control plane assistance information, of the apparatus, related to a first RAN wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; obtain configuration information associated with the second RAN; and communicate, based on the configuration information, with the second RAN.

Another aspect provides an apparatus configured for wireless communications. The apparatus includes means for sending one or more indications of apparatus information comprising one or more of: UE control plane assistance information, of the apparatus, related to a first RAN wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; means for obtaining configuration information associated with the second RAN; and means for communicating, based on the configuration information, with the second RAN.

Another aspect provides a non-transitory computer-readable medium. The computer-readable medium has instructions stored thereon, that when executed by an apparatus, cause the apparatus to perform a method. The method includes sending one or more indications of apparatus information comprising one or more of: UE control plane assistance information, of the apparatus, related to a first RAN wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Another aspect provides a method for wireless communications by an apparatus. The method includes receiving one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Another aspect provides an apparatus configured for wireless communications. The apparatus includes one or more memories and one or more processors coupled to the one or more memories. The one or more processors are configured to cause the apparatus to receive one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN; obtain configuration information associated with the second RAN; and communicate, based on the configuration information, with the second RAN

Another aspect provides an apparatus configured for wireless communications. The apparatus includes means for receiving one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN; means for obtaining configuration information associated with the second RAN; and means for communicating, based on the configuration information, with the second RAN.

Another aspect provides a non-transitory computer-readable medium. The computer-readable medium has instructions stored thereon, that when executed by an apparatus, cause the apparatus to perform a method. The method includes receiving one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts example connectivity for a dual stack configured UE.

FIG. 6 depicts a process flow for communications between a UE, a first network entity associated with a first radio access network (RAN), a second network entity associated with a second RAN, and a core network (CN) associated with the second RAN for connection establishment.

FIG. 7 depicts a process flow for communications between a UE, a first network entity associated with a first RAN, a second network entity associated with a second RAN, and a CN associated with the second RAN to indicate that dual connectivity by the UE is not allowed.

FIG. 8 depicts a process flow for communications between a UE, a first network entity associated with a first RAN, a second network entity associated with a second RAN, and a CN associated with the second RAN for establishing connectivity for the UE based on one or more conditions.

FIG. 9 depicts a process flow for communications between a UE, a first network entity associated with a first RAN, a second network entity associated with a second RAN, and a CN associated with the second RAN to configure the UE for a dual connectivity operation.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure relate to enhanced signaling designs used to support dual stack (e.g., including dual connectivity) configuration and operation. For example, the signaling designs described herein may support dual stack configuration and operation for a user equipment (UE) that has the capability to connect to two network entities, operating different radio access technologies (RATs) in different radio access networks (RANs), simultaneously for the transmission and/or reception of data. As used herein, a “RAN” is a component of a telecommunications system that may connect devices to a cellular network. Further, “simultaneous connection” may refer to a connection of a UE to a first network entity and a second network entity at the same time for at least a single instance in time. Dual connectivity communications, as well as dual stack communications (e.g., one type of dual connectivity communications), are described in detail below. Although certain techniques are discussed herein with respect to dual stack communications, it should be noted that these techniques may also similarly apply to or enhance other types of dual connectivity and/or multi-connectivity communications.

Dual connectivity is a solution in wireless communications systems that enables a UE to consume radio resources of two network entities (e.g., operating same or different RATs), at the same time, in order to enhance user experience and network efficiency. For example, dual connectivity allows a UE to be connected simultaneously to two different cell groups associated with two different network entities, such as a first network entity and a second network entity. A “cell group” may refer to or correspond to multiple carriers (e.g., associated with specific frequencies) used for wireless communications with the first network entity or the second network entity. Dual stack is one dual connectivity design where the connections allowed are between a UE and two network entities of different RANs. For example, the first network entity may establish a first backhaul link with a first core network (CN), where the first network entity and the first CN are associated with a first RAN (e.g., implementing a first access technology (RAT), such as 5G). Further, the second network entity may establish a second backhaul link with a second CN, where the second network entity and the second CN are associated with a second RAN (e.g., implementing a second RAT, such as 6G).

A radio resource control (RRC) state of the UE in the first RAN or the second RAN may be (1) a connected state (also referred to as a “connected mode,” “RRC connected mode,” and/or “RRC connected state”), (2) an inactive state (also referred to as an “inactive mode,” “RRC inactive mode,” and/or “RRC inactive state”), or (3) an idle state (also referred to as an “idle mode,” “RRC idle mode,” and/or “RRC idle state”). The UE may be operating in a connected state in the first RAN or the second RAN after establishing an RRC connection with the first network entity in the first RAN or the second network entity in the second RAN, respectively. The UE may be operating in an idle state in the first RAN or the second RAN when the UE is not connected, or in other words, does not have an established RRC connection with the first network entity in the first RAN or the second network entity in the second RAN, respectively.

For dual stack, an increase in overall throughput, and accordingly data rates for the UE, may be achieved by aggregating radio resources from at least the two network entities. Further, mobility robustness may be achieved by being simultaneously connected to the different cell groups. For example, uninterrupted communication and/or smooth handovers (e.g., procedures used to transfer a UE from a source cell or network entity to a target cell or network entity) may be realized, even in cases where the UE is moving at high speeds. Dual stack may also help in load balancing by enabling the offloading of traffic between cell groups/network entities to distribute the traffic load of the UE and/or help prevent congestion in the RAN associated with the first network entity and/or the second network entity. Moreover, dual stack capability configured at the UE may allow the UE to leverage the capabilities of different networks in cases where the first network entity is associated with a first RAN and the second network entity is associated with a second RAN. This may help to ensure interoperability of the networks without disrupting existing services.

Certain aspects described herein provide signaling designs used to support dual stack configuration and operation for a dual stack configured device, such as a UE. In one or more aspects, the signaling designs may enable the UE to inform a network entity, associated with a first RAN, about its dual stack capability, or put differently, a capability of the UE to be connected to both the first RAN and a second RAN simultaneously. In certain aspects, the signaling designs may enable the UE to send, to a network entity associated with a first RAN, information about a RAN configuration of the UE in a second RAN, RAN capabilities of the UE in the second RAN, and/or a measurement report including measurements obtained by the UE and related to the first RAN. In certain aspects, the signaling designs may enable the UE to send, to a network entity associated with a first RAN, a measurement report including measurements obtained by the UE and related to a second RAN. In certain aspects, the signaling designs may enable a network entity, associated with a first RAN and connected to a UE, to limit when the UE is able to establish a second connection with another network entity (e.g., which may be associated with a second RAN).

The signaling described herein may occur when a UE is connected to only one network entity and is operating in a connected state in a first RAN associated with the network entity. In some cases, the signaling may result in the UE establishing a second connection with a second network entity associated with a second RAN, such that the UE is operating in a connected state in both the first and second RANs. In such cases, the UE may be able to realize one or more of the aforementioned benefits of a dual stack implementation. While aspects herein are described with respect to dual connectivity implementations including a UE, a first network entity, and a second network entity, aspects of the present disclosure may likewise be applicable to multi-connectivity designs where a UE is connected to more than two network entities.

The techniques described herein may allow a network entity to make communications decisions for a UE that improve overall communications, such as throughput, latency, etc. for the UE.

For example, as described in detail below, a first network entity may allow a UE to connect to a second network entity (e.g., carry out a dual stack operation) only when the additional connection is justified. An additional connection may be justified when communication performance (e.g., throughput, latency, etc.) via the single communications link between the first network entity and the UE is insufficient (e.g., does not meet quality of service (QOS) requirements, where QoS refers to the description or measurement of the overall quality of wireless communications experienced by the UE). Thus, if the communication performance via the single communications link is sufficient, the first network entity may limit the UE from establishing the second connection, given there may be nominal benefit to establishing a second connection with the second network entity. The first network entity may prohibit the UE from establishing the second connection in this case to avoid increased resource and/or power consumption at the UE to establish the second connection, and/or increased radio frequency (RF) signal complexity at the UE after the second connection has been established.

As another example described in detail below, a first network entity (e.g., in a first RAN) may allow a UE to connect to and offload traffic to a second network entity (e.g., in a second RAN) only when signal levels (e.g., reference signal receive power (RSRP), signal-to-noise ratio (SNR), etc.) in the second RAN are better than signal levels measured in the first RAN. By limiting the dual stack operation of the UE to such scenarios, a QoS experienced by the UE (e.g., latency, throughput, etc.) may, at the least, be maintained.

As another example described in detail below, providing, to a second network entity (e.g., in a second RAN), information about a UE's dual stack capability and/or current RAN configuration in a first RAN (e.g., when establishing a second connection in the second RAN) may help the second network entity to better configure the UE in the second RAN to avoid performance degradation(s) experienced by the UE. For example, the first RAN configuration for the UE may schedule time periods for the UE to perform one or more measurements of one or more resources. If the second network entity (e.g., in the second RAN) is aware of these scheduled measurement time periods, then the second network entity may avoid scheduling duplicate time periods for the UE to perform such measurement(s) of the same resource(s). Accordingly, throughput at the UE may be saved. Similarly, other performance degradation(s) may be avoided by providing the UE's dual stack capability and/or first RAN configuration to the second network entity.

The techniques discussed herein may be applicable to multi-SIM technologies, multicast and broadcast services (MBS) technologies, etc. For example, in such technologies, multi-RAN communications and/or communications involving two or more network entities, operators, etc. may exist; thus, similar benefits, as those described herein, may be realized.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

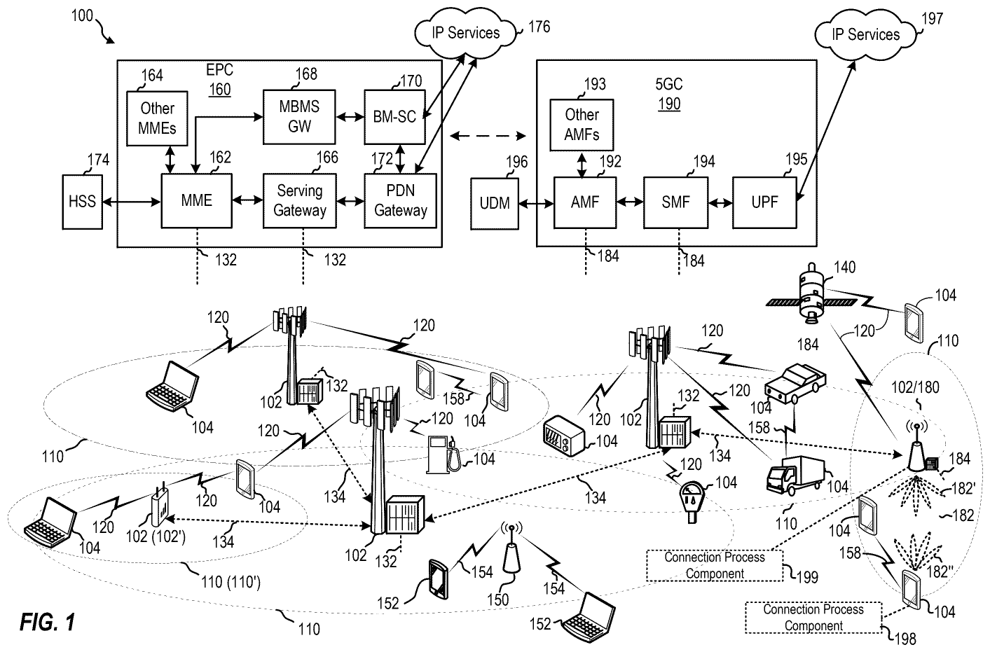

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) that have the capability to communicate with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

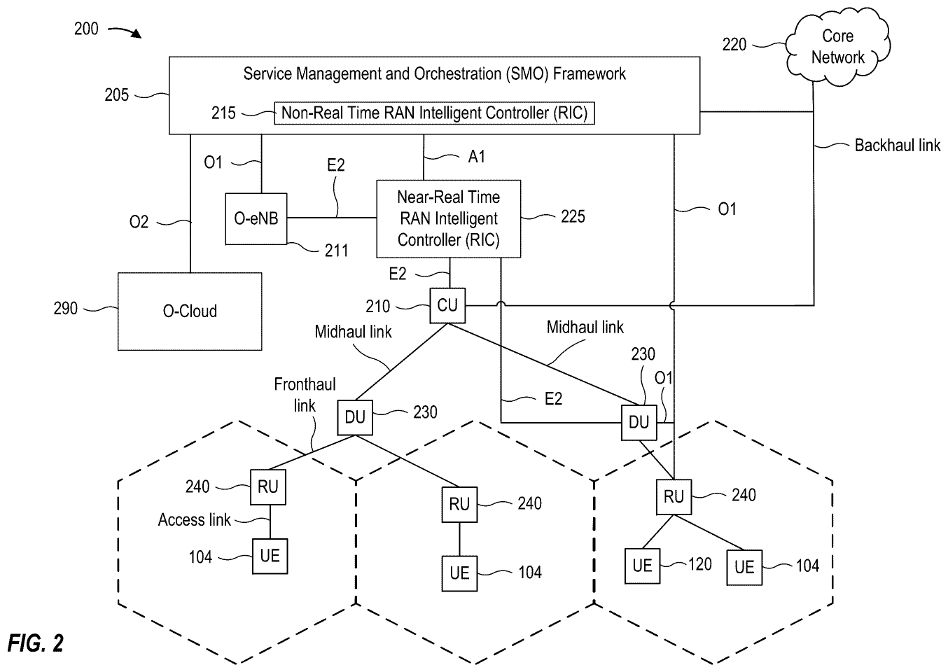

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHZ, which is sometimes referred to (interchangeably) as a “millimeter wave” (“mmW” or “mm Wave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

UE 104 includes a connection process component 198, which may be used to send one or more indications of apparatus information to support dual stack configuration and operation as further described herein. Further, network entity 102 includes a connection process component 199, which may be used to receive one or more indications of apparatus information to support dual stack configuration and operation as further described herein.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

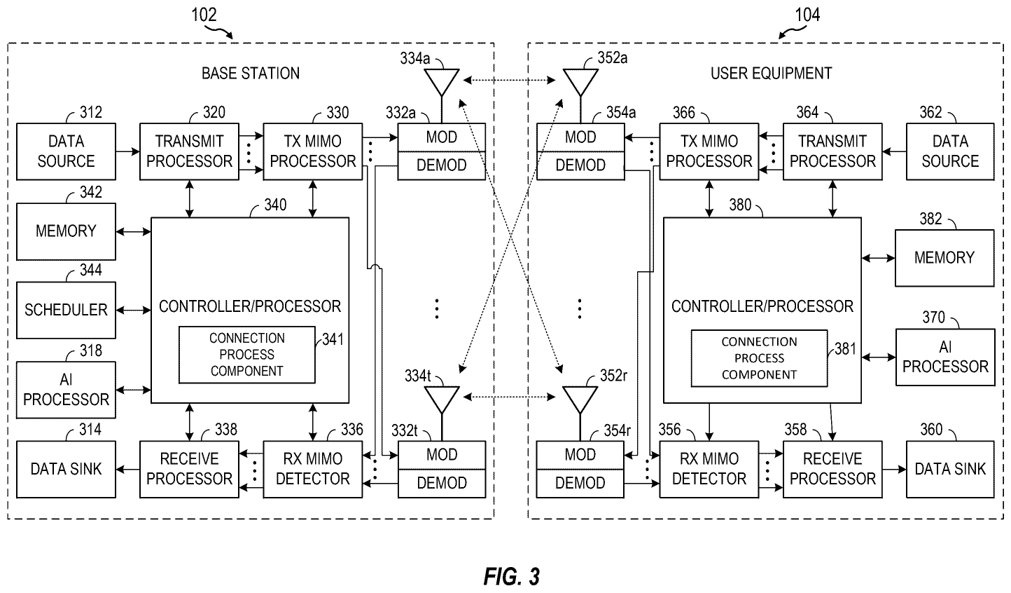

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

In the depicted example, controller/processor 340 includes a connection process component 341, which may be representative of the connection process component 199 of FIG. 1. Notably, while depicted as an aspect of controller/processor 340, the connection process component 341 may be implemented additionally or alternatively in various other aspects of base station 102 in other implementations. Further, controller/processor 380 includes a connection process component 381, which may be representative of the connection process component 198 of FIG. 1. Notably, while depicted as an aspect of controller/processor 380, the connection process component 381 may be implemented additionally or alternatively in various other aspects of user equipment 104 in other implementations.

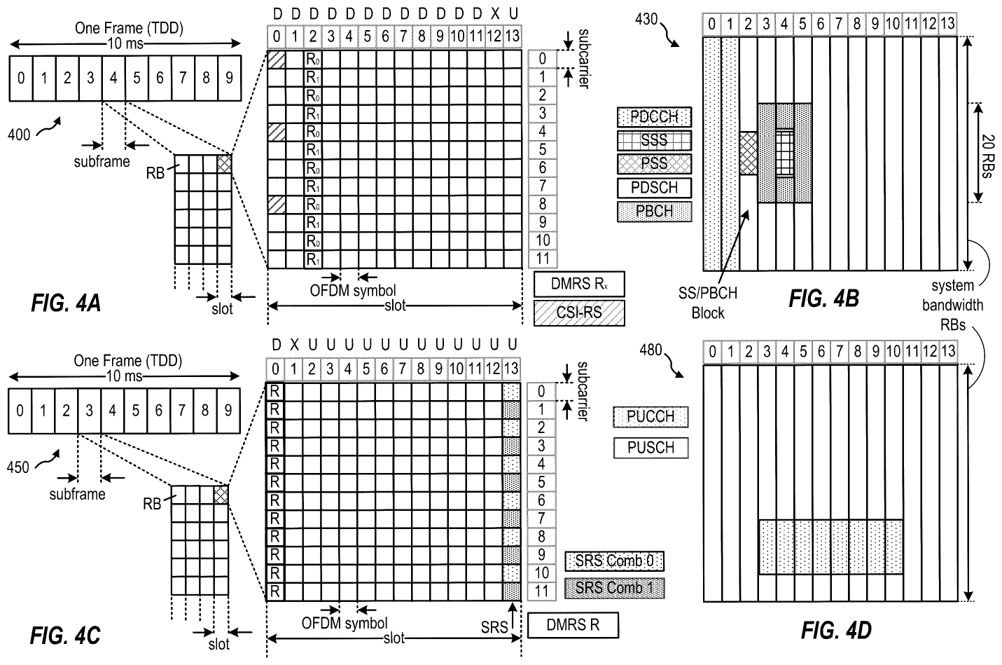

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology u, there are 24 slots per subframe. Thus, numerologies (u) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 24×15 kHz, where u is the numerology 0 to 6. As an example, the numerology u=0 corresponds to a subcarrier spacing of 15 kHz, and the numerology u=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology u=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to UE Dual Stack

Dual connectivity refers to the concurrent use of two independent communication paths and network entities (e.g., BSs such as BS 102 depicted and described with respect to FIGS. 1 and 3 or a disaggregated base station depicted and described with respect to FIG. 2) for data transmission to/from a UE. For example, where a UE is configured with dual connectivity, the UE may simultaneously transmit and receive data on different cell groups associated with two different network entities. In some cases, the network entities are associated with a same RAN implementing same RAT (e.g., 3G, 4G, 5G, and/or 6G). In some other cases, the network entities are associated with different RANs implementing different RATs. The UE may be configured with dual stack (e.g., one type of dual connectivity communication) when the network entities are associated with different RANs implementing different RATs.

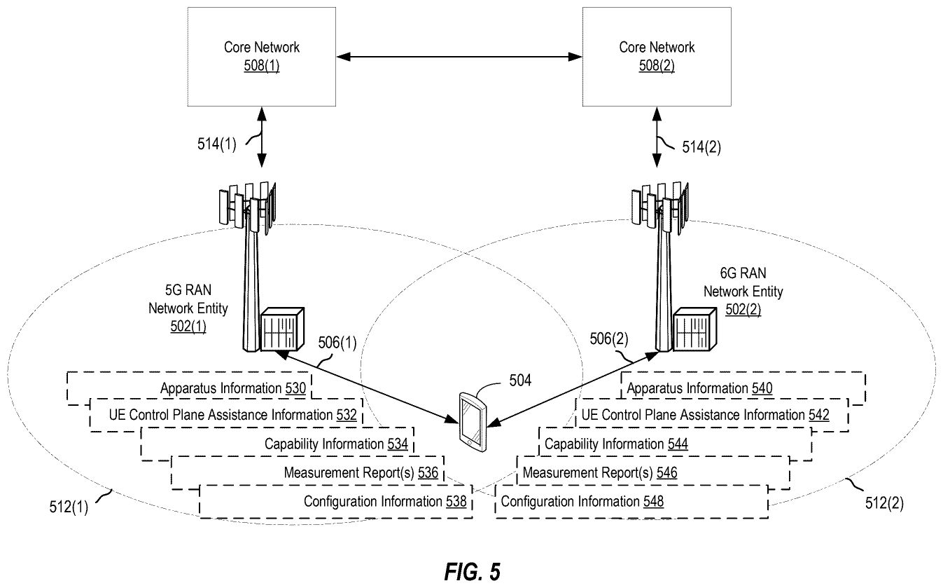

FIG. 5 depicts an example dual stack operation. As shown, UE 504 (e.g., such as UE 104 of FIGS. 1 and 3 configured with dual stack capability) may establish a first RRC connection and a first communication link 506(1) with a first network entity 502(1) (e.g., via a Uu interface). In certain aspects, first network entity 502(1) is associated with a first RAN and is configured to support a first RAT, for example, 5G RAT. Additionally, UE 504 may establish a second RRC connection and a second communication link 506(2) with a second network entity 502(2) (e.g., via a Uu interface). In certain aspects, second network entity 502(2) is associated with a second RAN, and may be configured to support a second RAT, for example, 6G RAT. UE 504 may establish both first communication link 506(1) and second communication link 506(2) when UE 504 is located within a coverage area (e.g., cell 512(1) and cell 512(2)) served by both first network entity 502(1) and second network entity 502(2).

In some aspects, first network entity 502(1) communicates with second network entity 502(2) via core network 508(1) (e.g., a 5G core network) and core network 508(2) (e.g., a 6G core network). Specifically, first network entity 502(1) may establish a first backhaul link 514(1) with core network 508(1) to communicate data between first network entity 502(1) and core network 508(1). Additionally, second network entity 502(2) may establish a second backhaul link 514(2) with core network 508(2) to communicate data between second network entity 502(2) and core network 508(2). Communication between core network 508(1) and core network 508(2) may also be established to communicate data between first network entity 502(1) and second network entity 502(2).

After establishing an RRC connection with first network entity 502(1) and second network entity 502(2), UE 504 may be operating in a connected state with first network entity 502(1) and second network entity 502(2). At some later time, an RRC state (or mode) of UE 504 may change from the connected state to an idle state or an inactive state. State information of the RRC connection for UE 504 may be maintained at UE 504 and the first network entity 502(1) and/or second network entity 502(2).

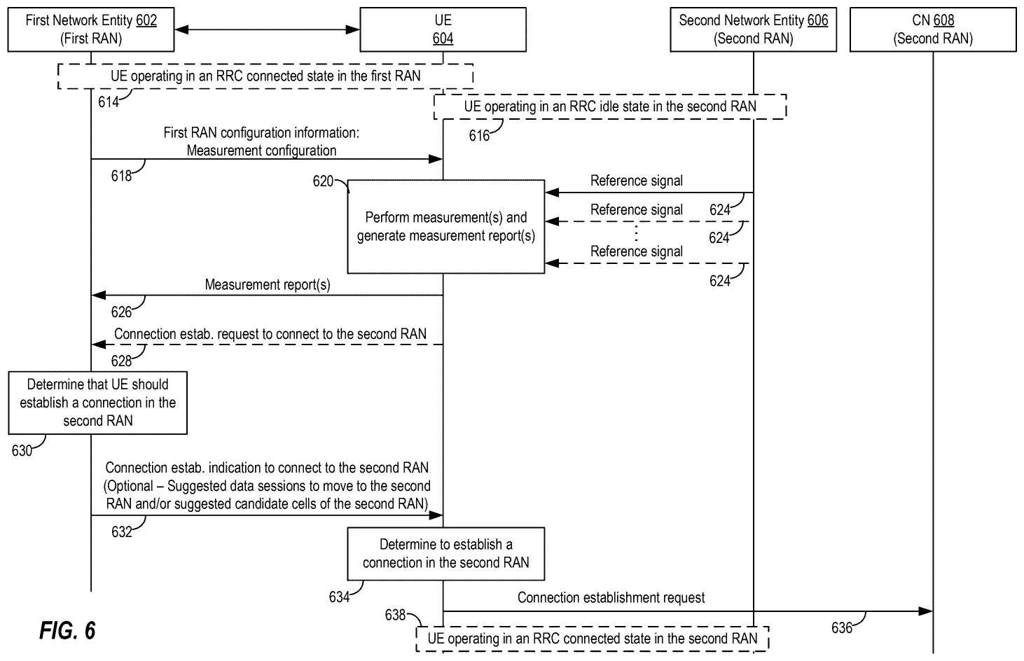

In certain aspects, UE 504 exchanges information with first network entity 502(1). The information may include apparatus information 530, UE control plane assistance information 532, capability information 534, measurement report(s) 536, and/or configuration information 538, which are described in detail below with respect to FIGS. 6-9. In certain aspects, UE 504 exchanges information with second network entity 502(2). The information may include apparatus information 540, UE control plane assistance information 542, capability information 544, measurement report(s) 546, and/or configuration information 548, which are described in detail below with respect to FIGS. 6-9.

Dual stack designs, such as the dual stack operation of UE 504 illustrated in FIG. 5, provide many benefits, including but not limited to, load balancing between network entities (e.g., first network entity 502(1) and second network entity 502(2) in FIG. 5), enhanced network coverage, and improved data rates.

For example, dual stack may allow for the use of radio resources from two cells, resulting in higher data rates for UE 504. The combined capacity of the cells increases the overall throughput and enables faster download and upload speeds at UE 504. This may be particularly advantageous in areas with high user density and/or limited coverage. This may also help to improve data speeds, especially for applications that require a lot of bandwidth, such as streaming video and/or gaming applications.

Dual stack may also allow for load balancing between cells to optimize resource allocation and improve network efficiency. For example, first network entity 502(1) connected to UE 504 may offload traffic to the cells associated with the second network entity (of the two network entities), thereby distributing the load and preventing congestion in the network. This helps to ensure efficient utilization of available resources and/or improve overall network performance.

Dual stack may also help to improve network coverage by establishing connections with two cells (e.g., one cell associated with first network entity 502(1) and the one cell associated with second network entity 502(2)). This helps to create a more reliable connection for UE 504, as well as helps to reduce the likelihood of signal loss and/or degradation in challenging environments. For example, 5G and 6G wireless communication coverage may be available within a same geographic coverage area, and having UE 504 connect to both the 5G network and 6G network in this area (e.g., shown in FIG. 5) may provide for more reliable connection. For instance, if the 5G wireless connection becomes poor, UE 504 may drop its connection with first network entity 502(1) (e.g., configured to support 5G RAT) and still maintain a connection with second network entity 502(2) (e.g., configured to support 6G RAT) for data transmission and reception.

It is noted that, in some cases, the costs of achieving the aforementioned benefits outweigh the benefits obtained by implementing a dual stack operation. In some other cases, establishing a second connection, such that a UE is operating in two RANs, may not be justified due to, for example, sufficient QOS achieved during a single connection operation. As such, in some cases, it may not be beneficial for a UE to be connected to both the first RAN and the second RAN at the same time. Further, in some cases, establishing a second connection at a second network entity that is not aware of the first connection of the UE with a first network entity (e.g., in another RAN), may result in the UE being configured in the second RAN with a configuration that adversely affects communication performance of the UE (e.g., such as reduces throughput).

### Aspects Related to Supporting Dual Stack Configuration and Operation

Aspects described herein provide signaling designs used to support dual stack configuration and operation for a dual stack configured device, such as a UE. Such signaling designs may involve communication between the UE and a first network entity, associated with a first RAN (e.g., implementing a first RAT, such as 5G), and/or the UE and a second network entity, associated with a second RAN (e.g., implementing a second RAT, such as 6G). While aspects herein are described with respect to dual stack implementations including a UE, a first network entity, and a second network entity, aspects of the present disclosure may likewise be applicable to other dual connectivity and/or multi-connectivity designs where a UE is connected to two or more network entities. Aspects of the present disclosure may also be applicable to dual connectivity and/or multi-connectivity designs where another device is connected to multiple nodes.

In certain aspects, the signaling described herein occurs when the UE is RRC connected to only one of the network entities, such as the first network entity, and is operating in a connected state in the first RAN associated with the first network entity. The UE may be operating in an idle state in the second RAN associated with the second network entity given the UE has not established an RRC connection with the second network entity.

In certain aspects, the signaling designs described herein may be used to limit when the UE is allowed to utilize its ability to simultaneously connect to the first network entity and the second network entity.

For example, in certain aspects, the signaling may enable the first network entity to determine that a dual stack operation is warranted and/or can be justified for the UE and communicate this determination to the UE. For example, the communication may indicate that the UE is allowed to be connected to two RANs simultaneously, such as both the first RAN (e.g., associated with the first network entity) and the second RAN (e.g., associated with the second network entity) at the same time. This signaling is described in detail below with respect to FIG. 6.

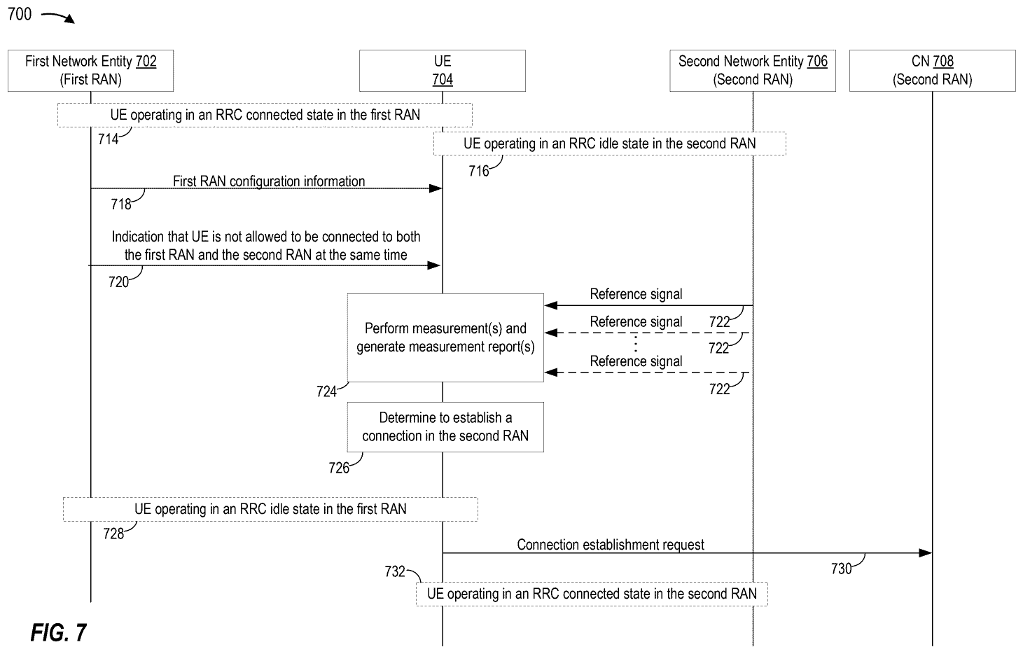

As another example, in certain aspects, the first network entity may determine that a dual stack operation is not warranted and/or cannot be justified for the UE. As such, the signaling may enable the first network entity to communicate this determination to the UE. For example, the first network entity may send, to the UE, an indication that that the UE is not allowed to be connected to two RANs simultaneously, such as both the first RAN (e.g., associated with the first network entity) and the second RAN (e.g., associated with the second network entity) at the same time. This signaling is described in detail below with respect to FIG. 7.

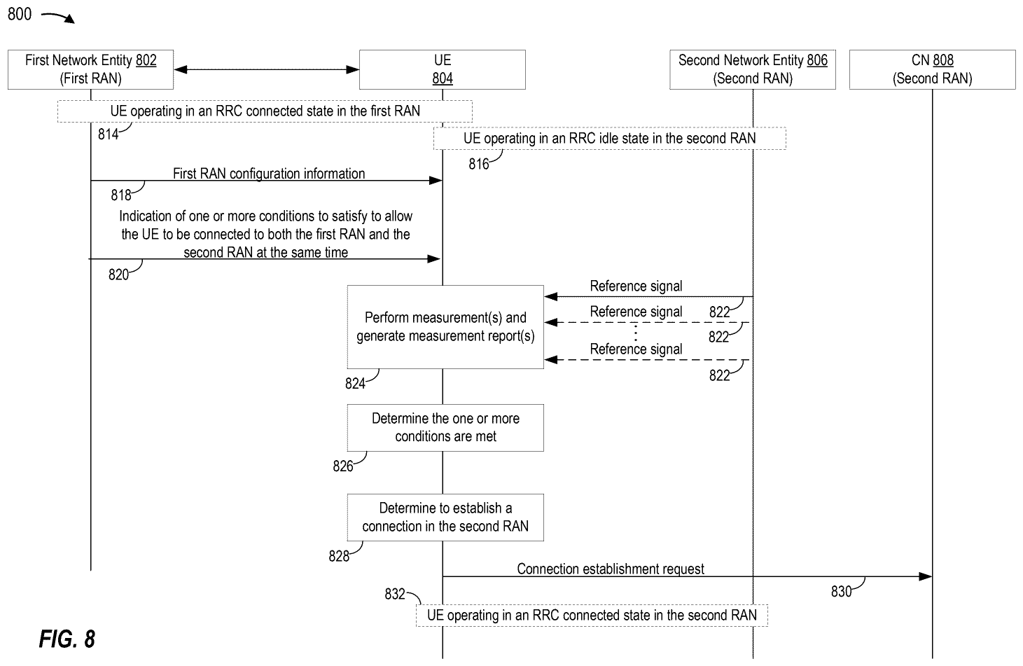

As another example, in certain aspects, the signaling may enable the first network entity to communicate one or more conditions to the UE. The condition(s), when satisfied, may allow the UE to establish a connection with the second network entity such that UE is connected to both the first network entity in the first RAN and the second network entity in the second RAN. This signaling is described in detail below with respect to FIG. 8.

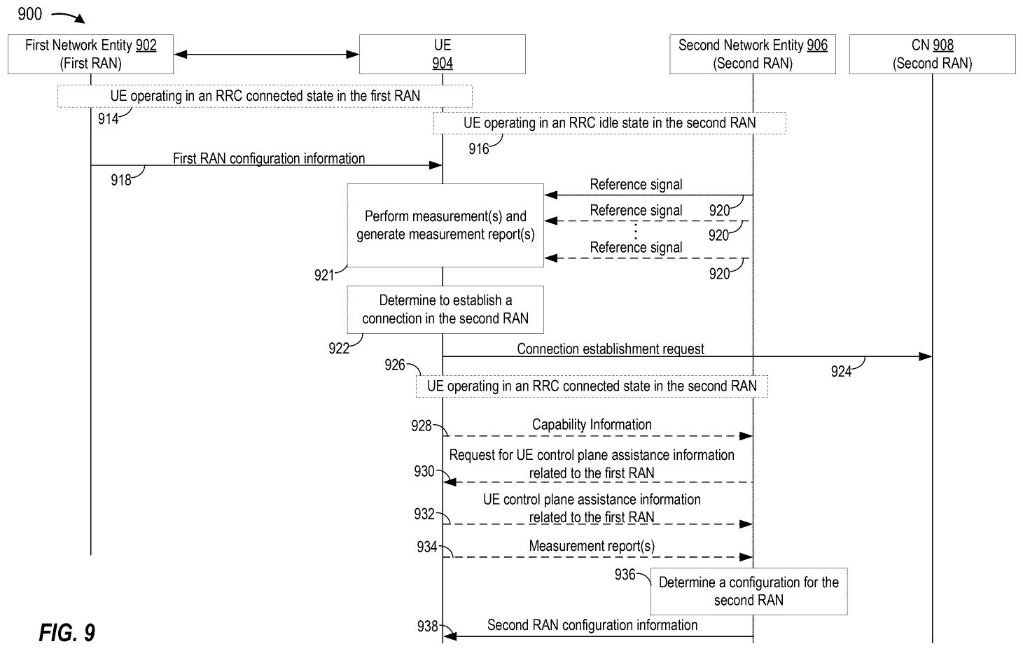

In cases where the UE is allowed to establish a connection with the second network entity (a dual stack operation is allowed), some signaling designs described herein may enable the UE to send, to the second network entity, (1) capability information, (2) UE control plane assistance information, and/or (3) one or more measurement reports. This signaling is described in detail below with respect to FIG. 9.

Example Signaling Supporting Dual Stack Configuration and Operation

The signaling designs described herein are provided in FIGS. 6, 7, 8, and 9. Each of FIGS. 6, 7, 8, and 9 depicts a process flow 600, 700, 800, 900, respectively, for communications in a network between a UE 604, 704, 804, 904, a first network entity 602, 702, 802, 902, a second network entity 606, 706, 806, 906, and a CN 608, 708, 808, 908, respectively. In certain aspects, first network entity 602, 702, 802, 902 and/or second network entity 606, 706, 806, 906 is an example of BS 102 depicted and described with respect to FIGS. 1 and 3 or a disaggregated BS depicted and described with respect to FIG. 2. UE 604, 704, 804, 904 may be an example of UE 104 depicted and described with respect to FIGS. 1 and 3. Similarly, CN 608, 708, 808, 908 may be an example of core network 220 depicted and described with respect to FIG. 2. However, in other aspects, UE 604, 704, 804, 904 may be another type of wireless communications device and first network entity 602, 702, 802, 902, second network entity 606, 706, 806, 906, and/or CN 608, 708, 808, 908 may be another type of network entity or network node, such as those described herein. Note that any operations or signaling illustrated with dashed lines may indicate that that operation or signaling is an optional or alternative example.

In certain aspects, UE 604, 704, 804, 904 is a dual stack configured UE that has the capability to connect to two network entities simultaneously for the transmission and/or reception of data. For example, UE 604, 704, 804, 904 may have the capability to connect to first network entity 602, 702, 802, 902 and second network entity 606, 706, 806, 906, respectively, at the same time. In certain aspects, first network entity 602, 702, 802, 902 is associated with a first RAN implementing a first RAT, such as 5G (e.g., first network entity 602, 702, 802, 902 is a 5G RAN node). In certain aspects, second network entity 606, 706, 806, 906 is associated with a second RAN implementing a second RAT, such as 6G (e.g., second network entity 606, 706, 806, 906 is a 6G RAN node). In certain aspects, CN 608, 708, 808, 908 is also associated with the second RAN and may be in direct communication with second network entity 606, 706, 806, 906, respectively.

Beginning with FIG. 6, a process flow 600 is depicted to illustrate communications between UE 604, first network entity 602, second network entity 606, and CN 608 for RAN-initiated dual stack establishment.

As shown in FIG. 6, process flow 600 begins, at 614, with UE 604 operating in an RRC connected state in the first RAN. For example, UE 604 may have previously established an RRC connection with first network entity 602 to be able to transmit and receive data with first network entity 602.

At 616, UE 604 is operating in an RRC idle state in the second RAN associated with second network entity 606. For example, UE 604 may not have an established RRC connection with second network entity 606 in the second RAN. As such, although UE 604 has to capability to carry out a dual stack operation, at the beginning of process flow 600, UE 604 may only be utilizing a single connection to first network entity 602.

At 618, first network entity 602 configures, UE 604, with a first RAN configuration (e.g., an example of configuration information 538 and/or configuration information 548 in FIG. 5) for operating in the first RAN.

In certain aspects, the first RAN configuration includes a data radio bearer (DRB) configuration of UE 604 in the first RAN. For example, UE 604, while in a connected state with first network entity 602, may be allocated one or more DRBs to exchange data/messages with first network entity 602. The DRB(s) may be used to transport first user plane application data (1) from UE 604 to first network entity 602 (e.g., uplink) and/or (2) from first network entity 602 to the UE 604 (e.g., downlink). A user plane, also referred to as a “data plane,” may be used to carry network user traffic. More specifically, a user plane may exist between UE 604 and first network entity 602 and may be configured to exchange data between UE 604 and first network entity 602.

In certain aspects, the first RAN configuration includes a carrier aggregation of UE 604 in the first RAN. For example, first network entity 602 may configure UE 604 with multiple component carriers for communication with first network entity 602. The multiple component carriers may correspond to multiple (serving) cells in the same cell group associated with first network entity 602. Per the carrier aggregation configuration, one of more of the component carriers may be activated at a time.

In particular, carrier aggregation is a technique used in wireless communication to increase the data rate per UE, whereby multiple frequency blocks (referred to as “component carriers”) are assigned to the same UE for data transmission and/or reception. Carrier aggregation enables multiple component carriers to be aggregated and simultaneously communicated between the UE and a network entity (e.g., to/from the UE) to increase the frequency bandwidth for communication. When carrier aggregation is used, one serving cell exists per component carrier. However, the RRC connection is only handled by one cell, e.g., the primary cell, served by a primary component carrier. The other component carriers assigned to the UE are all referred to as secondary component carriers, which serve secondary serving cells. Secondary cells may be activated and/or deactivated. For example, a network entity may configure a UE with one or more component carriers, but deactivate all component carriers (and their associated cells) except the primary component carrier. When there is a large amount of data to be delivered to the UE in the downlink, however, the network entity may activate one or more secondary component carriers, and accordingly the secondary cell(s) associated with the one or more secondary component carriers, to maximize downlink throughput.

In certain aspects, the first RAN configuration includes a measurement configuration of UE 604 in the first RAN. For example, first network entity 602 may configure UE 604 with one or more measurement gaps. A measurement gap is an opportunity given to UE 604 (e.g., time-frequency resource(s) scheduled by first network entity 602 to allow UE 604) to perform one or more measurements on downlink signals. For example, UE 604 may not be able to perform such measurements while also transmitting and/or receiving; thus, first network entity 602 may configure UE 604 with the one or more measurement gap(s) that do not coincide with UE 604's transmissions and/or receptions. In certain aspects, first network entity 602 configures UE 604 with measurement gap(s) via RRC signaling. In certain aspects, the measurement gap(s) configured at UE 604 may allow UE 604 to perform measurement(s) for downlink signal(s) sent in the first RAN (e.g., 5G RAN) and/or downlink signal(s) sent in the second RAN (e.g., 6G RAN).

At 624, second network entity 606 sends one or more reference signals in the second RAN. Second network entity 606 may send the reference signal(s) during one or more of the measurement gaps configured at UE 604. As such, UE 604 may monitor for and detect the reference signal(s) sent by second network entity 606 during the measurement gap(s) configured at UE 604. And, at 620, UE 604 may measure the received reference signal(s) and generate one or more measurement reports. In certain aspects, UE 604 may obtain RSRP measurement(s), reference signal strength indicator (RSSI) measurement(s), and/or reference signal received quality (RSRQ) measurement(s) based on measuring the one or more reference signals sent during the configuring measurement gap(s). In certain aspects, UE 604 may generate one or more measurement reports with one or more of the RSRP measurements, one or more of the RSSI measurements, and/or one or more of the RSRQ measurements.

At 626, UE 604 sends, to first network entity 602, the measurement report(s) (e.g., an example of apparatus information 530, measurement report(s) 536, apparatus information 540, and/or measurement report(s) 546 in FIG. 5). At 630, first network entity 602 determines that UE 604 may establish a connection in the second RAN. First network entity 602 may make this determination based on at least some of the information included in the measurement report(s) sent to first network entity 602.

For example, one measurement report may include an RSRP value indicating the current connection/signal strength between UE 604 and second network entity 606. First network entity 602 may use this RSRP to make an informed decision about whether or not UE 604 may establish a second connection in the second RAN. In cases where the RSRP value indicates that the connection/signal strength is poor between UE 604 and second network entity 606, then first network entity 602 may determine that the dual stack operation of UE 604 is not warranted, nor justified. Thus, first network entity 602 may determine that UE 604 may not establish a connection in the second RAN. On the other hand, in cases where the RSRP value indicates that the connection/signal strength is good, first network entity 602 may determine that the dual stack operation of UE 604 is warranted. A connection/signal strength may be poor (also referred to herein as “weak”) when the RSRP value is below a threshold, when the RSRP value is below an RSRP measured for communication(s) between UE 604 and first network entity 602, etc. A connection/signal strength may be good (also referred to herein as “strong”) when the RSRP value is above a threshold, when the RSRP value is above an RSRP measured for communication(s) between UE 604 and first network entity 602, etc.

Further, in some cases, first network entity 602 may make this determination (e.g., at 630) based on UE 604's traffic (e.g., traffic originating from and/or intended for the UE) exchanged between UE 604 and first network entity 602. For example, if the first RAN is congested and first network entity 602 determines that there exists a strong connection/signal strength between UE 604 and second network entity 606 in the second RAN, then first network entity 602 may determine that the dual stack operation of UE 604 is warranted. As above, a connection/signal strength may be strong (also referred to herein as “good”) when the RSRP value is above a threshold, when the RSRP value is above an RSRP measured for communication(s) between UE 604 and first network entity 602, etc.

Further, in some cases, first network entity 602 may make this determination (e.g., at 630) based on user plane measurement(s) for a user plane configured for exchanging information between UE 604 and first network entity 602. The user plane measurement(s) may include information about uplink throughput, downlink throughput, uplink packet delay, downlink packet delay, packet loss rate, uplink capacity, downlink capacity, and/or the like. In certain aspects, the user plane measurement(s) may be associated with or more DRBs (e.g., used to transport user plane application data) associated with the first user plane. For example, if the downlink throughput for the user plane between first network entity 602 and UE 604 is below a threshold throughput value (e.g., indicating that the throughput does not meet throughput requirements) and there exists a strong connection/signal strength between UE 604 and second network entity 606 in the second RAN, then first network entity 602 may determine that dual stack operation of UE 604 is warranted. Alternatively, if the downlink throughput for the user plane between first network entity 602 and UE 604 is above a threshold throughput value, thereby indicating that the throughput meets throughput requirements, then first network entity 602 may determine that the dual stack operation of UE 604 is not justified. For example, the gain achieved by establishing a dual stack operation may be minimal compared to costs that UE 604 may incur by establishing this second connection (e.g., increased resource consumption, increased RF signal complexity, etc.).

In certain aspects, first network entity 602 may make this determination (e.g., at 630) based on a connection establishment request from UE 604. For example, optionally at 628, UE 604 may send, to first network entity 602, a connection establishment request requesting to establish a second connection in the second RAN, using its dual stack capability. In certain aspects, UE 604 may determine to establish a second connection in the second RAN based on the measurement(s) obtained at 620 and/or user plane measurement(s) for the user plane configured for exchanging information between UE 604 and first network entity 602. In certain aspects, first network entity may determine, at 630, that UE should establish a connection in the second RAN based on the request to establish the second connection received from UE 604.

In this example, first network entity 602 determines, at 630, that UE 604 should establish a connection in the second RAN. Thus, at 632, first network entity 602 sends, to UE 604, a connection establishment indication to connect to the second RAN (e.g., example configuration information associated with the second RAN). In certain aspects, first network entity 602 sends the connection establishment indication in a system information (SI) message (e.g., such as a system information block 1 (SIB1)). In certain aspects, first network entity 602 sends the connection establishment indication via RRC signaling (e.g., via a dedicated RRC message intended for UE 604).

Optionally, at 630, first network entity 602 may also send, to UE 604, (1) one or more suggested data sessions to move from the first RAN to the second RAN and/or (2) one or more suggested candidate cells of the second RAN. The suggested data session(s) may include a subset of UE 604's traffic to offload from the first network entity 602 to second network entity 606. The suggested data session(s) sent to UE 604 may be associated with one or more DRBs associated with the first user plane between UE 604 and first network entity 602.

The suggested candidate cell(s) may be cell(s) associated with the second RAN that first network entity determines UE 604 should establish a connection within in the second RAN. The candidate cell(s) suggested by first network entity 602 may be selected by first network entity 602 based on at least some of the information included in the measurement report(s) sent to first network entity 602 (e.g., at 626). For example, the measurement report(s) may include information about different RSRP associated with different 6G RAN candidate cells. First network entity 602 may suggest a subset of the 6G RAN candidate cells based on the RSRP associated with each candidate cell in this subset satisfying a threshold RSRP (e.g., first network entity 602 may suggest a candidate cell with sufficient RSRP, which indicates that there exists a strong connection/signal strength between UE 604 and second network entity 606 in that candidate cell).

At 634, UE 604 determines to establish a second connection in the second RAN. UE 604 may make this determination based, at least in part, on receiving the connection establishment indication from first network entity 602.

Accordingly, at 636, UE 604 sends a connection establishment request to CN 608. More specifically, UE 604 may send the request to CN 608 via second network entity 606 (e.g., second network entity 606 may act as a relay to send the request to CN 608). Based on sending the connection establishment request at 636, UE 604 establishes a second connection with second network entity 606 in the second RAN, while also maintaining its current connection to first network entity 602 in the first RAN. After establishing a connection to second network entity 606, at 638, UE 604 may be operating in an RRC connected state in the RAN.

FIG. 7 depicts a process flow 700 for communications between UE 704, first network entity 702, second network entity 706, and CN 708 to indicate that a dual stack operation by the UE is not allowed.

As shown in FIG. 7, similar to process flow 600 in FIG. 6, process flow 700 begins, at 714, with UE 704 operating in an RRC connected state in the first RAN. For example, UE 704 may have previously established an RRC connection with first network entity 702 to be able to transmit and receive data with first network entity 702. At 716, UE 704 is operating in an RRC idle state in the second RAN associated with second network entity 706. For example, UE 704 may not have an established RRC connection with second network entity 706 in the second RAN. As such, although UE 704 has the capability to carry out the dual stack operation, at the beginning of process flow 700, UE 704 may only be utilizing a single connection to first network entity 702.

At 718, first network entity 702 configures, UE 604, with a first RAN configuration (e.g., an example of configuration information 538 and/or configuration information 548 in FIG. 5) for operating in the first RAN. The first RAN configuration may include a DRB configuration of UE 704 in the first RAN, a carrier aggregation of UE 704 in the first RAN, and/or a measurement configuration of UE 704 in the first RAN.

Unlike process flow 600 in FIG. 6, at 720 in process flow 700, first network entity 702 sends, to UE 704, an indication that UE 704 is not allowed to be connected to both the first RAN and the second RAN at the same time. In certain aspects, first network entity 702 determines to send the indication, at 720, based on policy information associated with UE 704. For example, the policy information may indicate that UE 704 is not allowed to connect to two RANs simultaneously. In certain aspects, first network entity 702 obtains the policy information associated with UE 704 from a CN in the first RAN (not shown in FIG. 7). In certain aspects, first network entity 702 sends the indication in an SI (e.g., such as a system information block 1 (SIB1)). In certain aspects, first network entity 702 sends the indication via RRC signaling (e.g., via a dedicated RRC message intended for UE 704).

Although FIG. 7 depicts first network entity 702 sending the indication to UE 704, in some other cases, the indication may be provided to UE 704 via a CN policy management node (not shown in FIG. 7), such as via first network entity 702. The CN policy management node may be associated with the first RAN or the second RAN. For example, the CN policy management node may provide the indication to UE 704 as part of a UE policy configured at UE 704.

Further, in some other cases (not shown in FIG. 7), second network entity 706 may send the indication to UE 704. For example, second network entity 706 may send the indication in an SI (e.g., such as a SIB1). Accordingly, when UE 704 is attempting to establish a connection with second network entity 706, UE 704 may receive the SI message with the indication and stop trying to establish a connection in the second RAN. In certain aspects, first network entity 702 may send the indication via RRC signaling (e.g., via a dedicated RRC message intended for UE 704).

In some other cases (not shown in FIG. 7), instead of the indication being sent to UE 704, the indication may be part of policy information pre-configured at UE 704.

At 722, second network entity 706 sends one or more reference signals in the second RAN. Second network entity 706 may send the reference signal(s) during one or more measurement gaps configured at UE 704 (e.g., via the measurement configuration at 718). UE 704 may monitor for and detect the reference signal(s) sent by second network entity 706 during the measurement gap(s) configured at UE 704. At 724, UE 704 may measure the received reference signal(s) and generate one or more measurement reports. The measurement report(s) may include the measurement(s) obtained by UE 704.

At 726, UE 704 determines to establish a connection to the second RAN. UE 704 may make this determination based on the measurement(s) obtained at 724. However, UE 704 is not allowed to be connected to both the first RAN and the second RAN at the same time, based on the indication received at 720. Thus, to connect to second network entity 706 in the second RAN, at 728, UE 704 may begin operating in an RRC idle state in the first RAN (e.g., such that no established communication in the first RAN exists).

At 730, UE 704 sends a connection establishment request to CN 708. More specifically, UE 704 may send the request to CN 708 via second network entity 706 (e.g., second network entity 706 may act as a relay to send the request to CN 708). Based on sending the connection establishment request at 730, UE 704 establishes a second connection with second network entity 706 in the second RAN. After establishing a connection to second network entity 706, at 732, UE 704 may be operating in an RRC connected state in the RAN.

FIG. 8 depicts a process flow 800 for communications between UE 804, first network entity 802, second network entity 806, and CN 808 for establishing a dual stack operation for UE 804 based on one or more conditions.

As shown in FIG. 8, similar to process flow 700 in FIG. 7, process flow 800 begins, at 814, with UE 804 operating in an RRC connected state in the first RAN. At 816, UE 804 is operating in an RRC idle state in the second RAN associated with second network entity 706. Although though UE 804 has the capability to carry out the dual stack operation, at the beginning of process flow 800, UE 804 may only be utilizing a single connection to first network entity 802.

At 818, first network entity 802 configures, UE 804, with a first RAN configuration (e.g., an example of configuration information 538 and/or configuration information 548 in FIG. 5) for operating in the first RAN. The first RAN configuration may include a DRB configuration of UE 804 in the first RAN, a carrier aggregation of UE 804 in the first RAN, and/or a measurement configuration of UE 804 in the first RAN.

Unlike process flow 700 in FIG. 7, at 820 in process flow 800, first network entity 802 sends, to UE 804, one or more conditions to satisfy for UE 804 to be allowed to be connected to both the first RAN and the second RAN at the same time. For example, if all condition(s) are met, then UE 804 may utilize its dual stack capability to connect to first network entity 802 and second network entity 806 simultaneously. In certain aspects, if any of the condition(s) are not met, then UE 804 may not be allowed to connect to first network entity 802 and second network entity 806 simultaneously.

In certain aspects, the one or more conditions include one or more measurement-related conditions. For example, one condition may be met when a received signal level (e.g., RSRP, signal-to-interference noise (SINR), etc.) in the first RAN satisfies (e.g., is greater than) a received signal level threshold (e.g., associated with the first RAN). Although not shown, UE 804 may obtain such measurement(s) for the RAN based on performing one or more measurements (e.g., RSRP measurement(s), SINR measurement(s), etc.) for the data exchanged on the first user plane between UE 804 and first network entity 802.

In certain aspects, the one or more conditions include one or more user plane-related conditions. For example, one condition may be met when a throughput in the first RAN satisfies (e.g., is greater than) a throughput threshold (e.g., associated with the first RAN). Another condition may be met when a packet delay in the first RAN satisfies (e.g., is greater than) a packet delay threshold (e.g., associated with the first RAN). Another condition may be met when a packet error rate in the first RAN satisfies (e.g., is greater than) a packet error rate threshold (e.g., associated with the first RAN). Although not shown, UE 804 may obtain such user plane value(s) for the RAN based on data exchanged on the first user plane between UE 804 and first network entity 802.

At 826, UE 804 determines the one or more conditions are met. As such, at 828, UE 804 determines to establish a connection to the second RAN (e.g., establishing the connection to the second RAN may be based on the one or more of the conditions being met).

At 830, UE 804 sends a connection establishment request to CN 808. More specifically, UE 804 may send the request to CN 808 via second network entity 806 (e.g., second network entity 806 may act as a relay to send the request to CN 808). Based on sending the connection establishment request at 830, UE 804 establishes a second connection with second network entity 806 in the second RAN. After establishing a connection to second network entity 806, at 832, UE 804 may be operating in an RRC connected state in the second RAN. As such, UE 804 may be connected to both first network entity 802 and second network entity 806 simultaneously.

FIG. 9 depicts a process flow for communications between UE 904, first network entity 902, second network entity 906, and CN 908 to configure UE 904 for a dual stack operation.

As shown in FIG. 9, similar to process flow 600 in FIG. 6, process flow 900 begins, at 914, with UE 904 operating in an RRC connected state in the first RAN. At 916, UE 904 is operating in an RRC idle state in the second RAN associated with second network entity 906. Although UE 904 has the capability to carry out the dual stack operation, at the beginning of process flow 900, UE 904 may only be utilizing a single connection to first network entity 902.

At 918, first network entity 902 configures, UE 904, with a first RAN configuration (e.g., an example of configuration information 538 and/or configuration information 548 in FIG. 5) for operating in the first RAN. The first RAN configuration may include a DRB configuration of UE 904 in the first RAN, a carrier aggregation of UE 904 in the first RAN, and/or a measurement configuration of UE 904 in the first RAN.

At 920, second network entity 906 sends one or more reference signals in the second RAN. Second network entity 906 may send the reference signal(s) during one or more measurement gaps configured at UE 904. As such, UE 904 may monitor for and detect the reference signal(s) sent by second network entity 606 during the measurement gap(s) configured at UE 604. A 921, UE 904 may measure the received reference signal(s) and generate one or more measurement reports. The measurement report(s) may include the measurement(s) obtained by UE 904.

At 922, UE 904 determines to establish a connection to the second RAN. UE 904 may make this determination based on the measurement(s) obtained at 921. In some other cases (although not shown in FIG. 9), UE 904 may make this determination based on receiving, from first network entity 902, a connection establishment indication to connect to the second RAN (e.g., as depicted and described with respect to FIG. 6).

At 924, UE 904 sends a connection establishment request to CN 908. More specifically, UE 904 may send the request to CN 908 via second network entity 906 (e.g., second network entity 906 may act as a relay to send the request to CN 908). Based on sending the connection establishment request at 924, UE 904 establishes a second connection with second network entity 906 in the second RAN. After establishing a connection to second network entity 906, at 926, UE 904 may be operating in an RRC connected state in the second RAN. As such, UE 904 may be connected to both first network entity 902 and second network entity 906 simultaneously.

Upon establishing the second connection to second network entity 906, UE 904 may optionally send, to second network entity 906 at 928, capability information of a capability of the UE 904 to be connected to both the first RAN and the second RAN at a same time (e.g., an example of apparatus information 530, capability information 534, apparatus information 540, and/or capability information 544 in FIG. 5). With this information, second network entity 906 may send, to UE 904 at 930, a request for UE control plane assistance information. The UE control plane assistance information may include (1) the RAN configuration of UE 904 for the first RAN and/or (2) one or more RAN capabilities of UE 904 for the first RAN, or the like. As described above, the RAN configuration of UE 904 for the first RAN may include a DRB configuration of UE 904 in the first RAN, a carrier aggregation of UE 904 in the first RAN, and/or a measurement configuration of UE 904 in the first RAN. RAN capabilities of UE 904 for the first RAN may include (1) band frequencies and/or band combinations that UE 904 supports for the first RAN, (2) a number of data radio bearers (DRBs) (e.g., of various types) that UE 904 supports in the first RAN, and/or (3) a maximum transmission power on uplink that UE 904 supports for the first RAN communications link, or the like.

In response to receiving the request, UE 904 may optionally, send to second network entity 906 at 932, the UE control plane assistance information (e.g., an example of apparatus information 530, UE control plane assistance information 532, apparatus information 540, and/or UE control plane assistance information 542 in FIG. 5) related to the first RAN. In some other cases, however, UE 904 may send the UE control plane assistance information to second network entity 906 without needing to send the capability information and the request, at 928 and 930, respectively.

Additionally, in some cases, UE 904 may optionally send, to second network entity 906 at 934, a measurement report (e.g., an example of apparatus information 530, measurement report(s) 536, apparatus information 540, and/or measurement report(s) 546 in FIG. 5) including measurement information related to communications in the first RAN.

At 936, second network entity 906 determines a configuration (referred to herein as “a second RAN configuration”) for the second RAN. Second network entity 906 may determine the configuration based on (1) the capability information, (2) the UE control plane assistance information, and/or (3) the measurement report. As such, the second RAN configuration may be based on UE 904 operating not only in the second RAN but also in the first RAN.

At 938, second network entity 906 configures, UE 904, with the second RAN configuration (e.g., an example of configuration information 538 and/or configuration information 548 in FIG. 5) for operating in the second RAN.

In certain aspects, sending the DRB configuration of UE 904 in the first RAN and/or the carrier aggregation of UE 904 in the first RAN, to second network entity 906 at 932, may be helpful for second network entity 906 to estimate uplink and/or downlink traffic load on the first RAN communications link. This information may be useful when determining the DRB configuration to provide to UE 904 in the second RAN.

In certain aspects, sending the measurement configuration for UE 904 in the first RAN, to second network entity 906 at 932, may help assist second network entity 906 in determining a measurement configuration for UE 904 in the second RAN. For example, if the measurement configuration of UE 904 in the first RAN includes gaps for performing one or more measurements, then second network entity 906 may not configure additional measurement gaps, as additional measurement gaps may cause UE 904 to lose on throughput. As such, one or more measurement gaps on certain frequencies may not need to be configured by second network entity 906 if UE 904 is already performing measurements for these frequencies per the measurement configuration of UE 904 in the first RAN. Second network entity 906 may then provide UE 904 with only a reporting configuration for measurements on those frequencies. In certain aspects, sending the measurement configuration for UE 904 in the first RAN, to second network entity 906 at 932, may help second network entity 906 determine a per-frequency resource measurement gap configuration.

### Example Operations

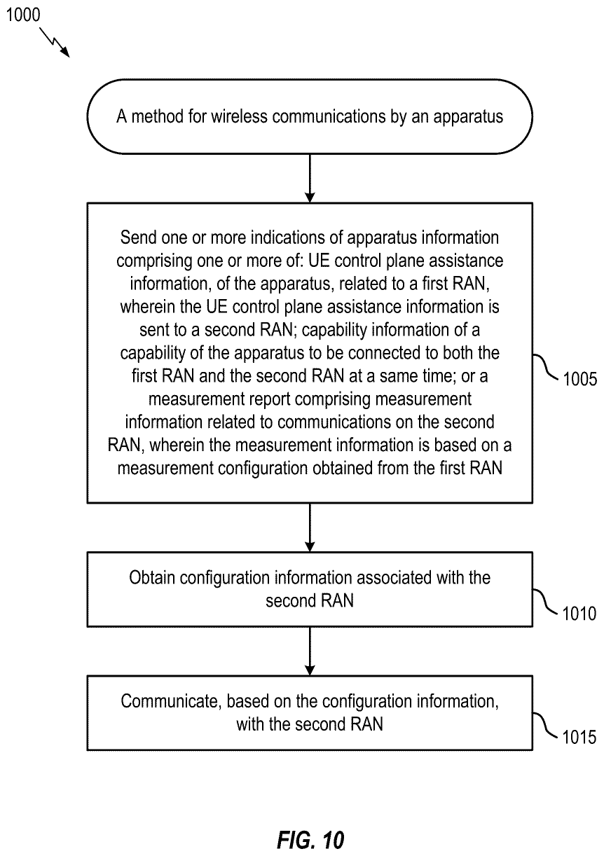

FIG. 10 shows a method 1000 for wireless communications by an apparatus, such as UE 104 of FIGS. 1 and 3.

Method 1000 begins at block 1005 with sending one or more indications of apparatus information comprising one or more of: UE control plane assistance information, of the apparatus, related to a first RAN, wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN.

Method 1000 then proceeds to block 1010 with obtaining configuration information associated with the second RAN.

Method 1000 then proceeds to block 1015 with communicating, based on the configuration information, with the second RAN.

In certain aspects, block 1005 includes sending the one or more indications to the second RAN.

In certain aspects, the apparatus information comprises the capability information.

In certain aspects, the apparatus information comprises the UE control plane assistance information; and the UE control plane assistance information comprises one or more of: a RAN configuration of the apparatus for the first RAN; or one or more RAN capabilities of the apparatus for the first RAN.

In certain aspects, the UE control plane assistance information comprises the RAN configuration; and the RAN configuration comprises one or more of: a data radio bearer configuration of the apparatus for the first RAN; a carrier aggregation configuration of the apparatus for the first RAN; or the measurement configuration.

In certain aspects, the apparatus information comprises the measurement report.

In certain aspects, block 1005 includes sending the one or more indications to the first RAN; and the apparatus information comprises the measurement report.

In certain aspects, the configuration information comprises: a connection establishment indication to connect to the second RAN.

In certain aspects, the configuration information comprises: one or more suggested data sessions to move from the first RAN to the second RAN; or one or more suggested candidate cells of the second RAN.

In certain aspects, method 1000 further includes obtaining an indication that the apparatus is not allowed to be connected to both the first RAN and the second RAN at the same time.

In certain aspects, obtaining the indication comprises obtaining the indication in one or more of a system information message or a dedicated radio resource control message.

In certain aspects, obtaining the indication comprises obtaining the indication as part of a policy configuration.

In certain aspects, obtaining the indication comprises obtaining the indication from a CN policy management node.

In certain aspects, method 1000 further includes obtaining an indication of one or more conditions to satisfy for the apparatus to be allowed to be connected to both the first RAN and the second RAN at the same time.

In certain aspects, the one or more conditions comprise at least one of: one or more measurement-related conditions associated with the first RAN; or one or more user plane-related conditions associated with the first RAN.

In certain aspects, the configuration information comprises one or more of: a data radio bearer configuration of the apparatus for the second RAN; a carrier aggregation configuration of the apparatus for the second RAN; or a measurement configuration of the apparatus for the second RAN.

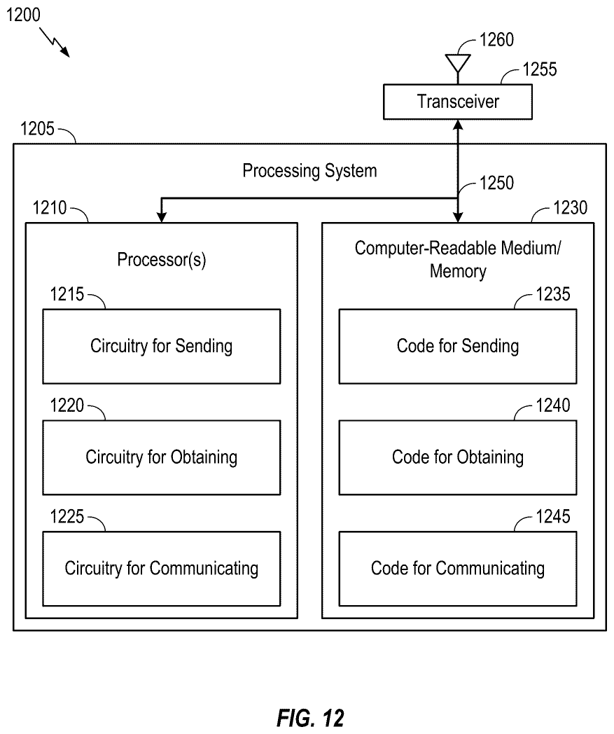

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

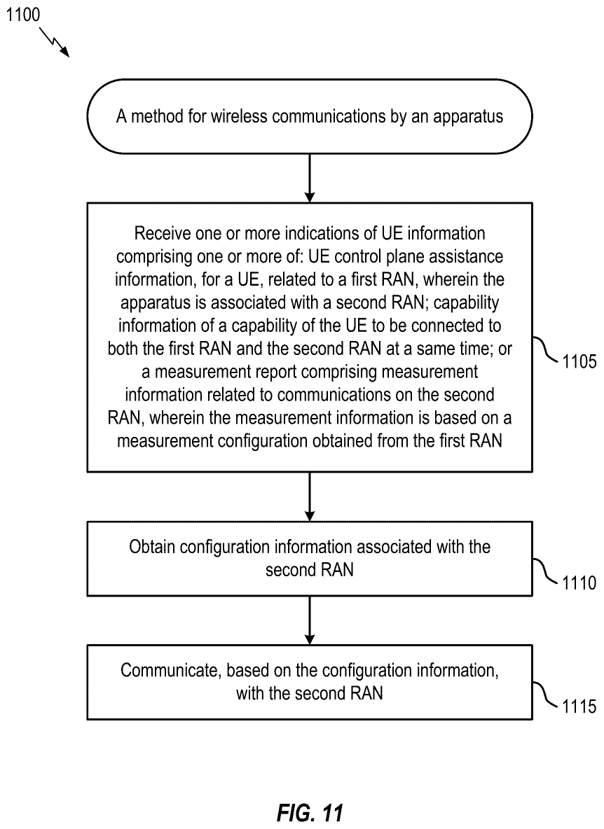

FIG. 11 shows a method 1100 for wireless communications by an apparatus, such as BS 102 of FIGS. 1 and 3, or a disaggregated base station as discussed with respect to FIG. 2.

Method 1100 begins at block 1105 with receiving one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN.

Method 1100 then proceeds to block 1110 with obtaining configuration information associated with the second RAN.

Method 1100 then proceeds to block 1115 with communicating, based on the configuration information, with the second RAN.

In certain aspects, the apparatus is associated with the second RAN.

In certain aspects, the UE information comprises the capability information.

In certain aspects, the UE information comprises the UE control plane assistance information; and the UE control plane assistance information comprises one or more of: a RAN configuration of the UE for the first RAN; or one or more RAN capabilities of the UE for the first RAN.

In certain aspects, the UE control plane assistance information comprises the RAN configuration; and the RAN configuration comprises one or more of: a data radio bearer configuration of the UE for the first RAN; a carrier aggregation configuration of the UE for the first RAN; or the measurement configuration.

In certain aspects, the UE information comprises the measurement report.

In certain aspects, the apparatus is associated with the first RAN; and the UE information comprises the measurement report.

In certain aspects, the configuration information comprises: a connection establishment indication to connect to the second RAN.

In certain aspects, the configuration information comprises: one or more suggested data sessions to move from the first RAN to the second RAN; or one or more suggested candidate cells of the second RAN.

In certain aspects, method 1100 further includes sending an indication that the UE is not allowed to be connected to both the first RAN and the second RAN at the same time.

In certain aspects, sending the indication comprises sending the indication in one or more of a system information message or a dedicated radio resource control message.

In certain aspects, sending the indication comprises sending the indication as part of a policy configuration.

In certain aspects, method 1100 further includes sending an indication of one or more conditions to satisfy for the UE to be allowed to be connected to both the first RAN and the second RAN at the same time.

In certain aspects, the one or more conditions comprise at least one of: one or more measurement-related conditions associated with the first RAN; or one or more user plane-related conditions associated with the first RAN.

In certain aspects, the configuration information comprises one or more of: a data radio bearer configuration of the UE for the second RAN; a carrier aggregation configuration of the UE for the second RAN; or a measurement configuration of the UE for the second RAN.

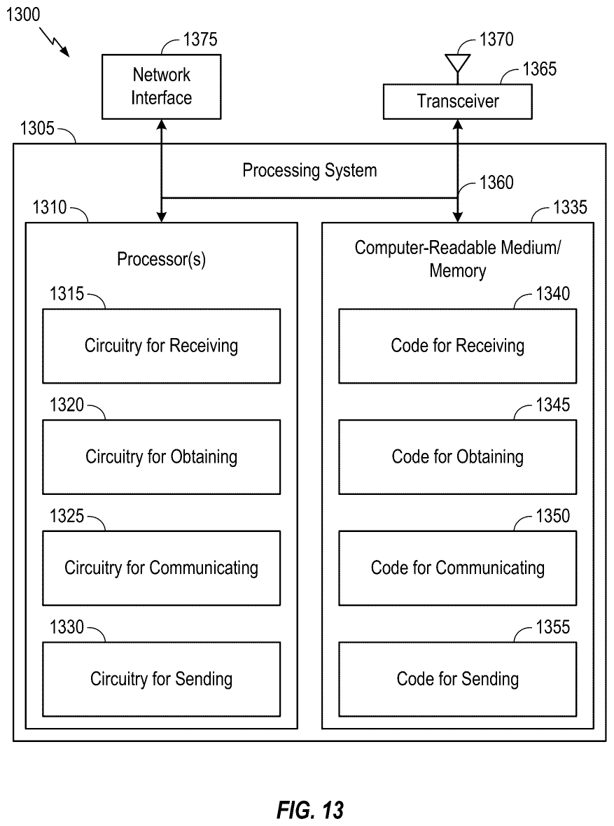

In certain aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200. In some aspects, communications device 1200 is a user equipment, such as UE 104 described above with respect to FIGS. 1 and 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210. In various aspects, the one or more processors 1210 may be representative of one or more of receive processor 358, transmit processor 364, TX MIMO processor 366, and/or controller/processor 380, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code) that when executed by the one or more processors 1210, enable and cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code for sending 1235, code for obtaining 1240, and code for communicating 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for obtaining 1220, and circuitry for communicating 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the transceivers 354, antenna(s) 352, receive processor 358, AI processor 370, and/or controller/processor 380 of the UE 104 illustrated in FIG. 3, transceiver 1255 and/or antenna 1260 of the communications device 1200 in FIG. 12, and/or one or more processors 1210 of the communications device 1200 in FIG. 12.

FIG. 13 depicts aspects of an example communications device 1300. In some aspects, communications device 1300 is a network entity, such as BS 102 of FIGS. 1 and 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310. In various aspects, one or more processors 1310 may be representative of one or more of receive processor 338, transmit processor 320, TX MIMO processor 330, and/or controller/processor 340, as described with respect to FIG. 3. The one or more processors 1310 are coupled to a computer-readable medium/memory 1335 via a bus 1360. In certain aspects, the computer-readable medium/memory 1335 is configured to store instructions (e.g., computer-executable code) that when executed by the one or more processors 1310, enable and cause the one or more processors 1310 to perform the method 1100 described with respect to FIG. 11, or any aspect related to it, including any operations described in relation to FIG. 11. Note that reference to a processor of communications device 1300 performing a function may include one or more processors of communications device 1300 performing that function, such as in a distributed fashion.

In the depicted example, the computer-readable medium/memory 1335 stores code for receiving 1340, code for obtaining 1345, code for communicating 1350, and code for sending 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for receiving 1315, circuitry for obtaining 1320, circuitry for communicating 1325, and circuitry for sending 1330. Processing with circuitry 1315-1330 may enable and cause the communications device 1300 to perform the method 1100 described with respect to FIG. 11, or any aspect related to it.

More generally, means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the transceivers 332, antenna(s) 334, receive processor 338, AI processor 318, and/or controller/processor 340 of the BS 102 illustrated in FIG. 3, transceiver 1365, antenna 1370, and/or network interface 1375 of the communications device 1300 in FIG. 13, and/or one or more processors 1310 of the communications device 1300 in FIG. 13.

### Example Clauses

Implementation examples are described in the following numbered clauses:

Clause 1: A method for wireless communications by an apparatus comprising: sending one or more indications of apparatus information comprising one or more of: UE control plane assistance information, of the apparatus, related to a first RAN, wherein the UE control plane assistance information is sent to a second RAN; capability information of a capability of the apparatus to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Clause 2: The method of Clause 1, wherein sending the one or more indications comprises sending the one or more indications to the second RAN.

Clause 3: The method of Clause 2, wherein the apparatus information comprises the capability information.

Clause 4: The method of Clause 2, wherein: the apparatus information comprises the UE control plane assistance information; and the UE control plane assistance information comprises one or more of: a RAN configuration of the apparatus for the first RAN; or one or more RAN capabilities of the apparatus for the first RAN.

Clause 5: The method of Clause 4, wherein: the UE control plane assistance information comprises the RAN configuration; and the RAN configuration comprises one or more of: a data radio bearer configuration of the apparatus for the first RAN; a carrier aggregation configuration of the apparatus for the first RAN; or the measurement configuration.

Clause 6: The method of Clause 2, wherein the apparatus information comprises the measurement report.

Clause 7: The method of any one of Clauses 1-6, wherein: sending the one or more indications comprises sending the one or more indications to the first RAN; and the apparatus information comprises the measurement report.

Clause 8: The method of Clause 7, wherein the configuration information comprises: a connection establishment indication to connect to the second RAN.

Clause 9: The method of Clause 7, wherein the configuration information comprises: one or more suggested data sessions to move from the first RAN to the second RAN; or one or more suggested candidate cells of the second RAN.

Clause 10: The method of any one of Clauses 1-9, further comprising: obtaining an indication that the apparatus is not allowed to be connected to both the first RAN and the second RAN at the same time.

Clause 11: The method of Clause 10, wherein obtaining the indication comprises obtaining the indication in one or more of a system information message or a dedicated radio resource control message.

Clause 12: The method of Clause 10, wherein obtaining the indication comprises obtaining the indication as part of a policy configuration.

Clause 13: The method of Clause 10, wherein obtaining the indication comprises obtaining the indication from a CN policy management node.

Clause 14: The method of any one of Clauses 1-13, further comprising: obtaining an indication of one or more conditions to satisfy for the apparatus to be allowed to be connected to both the first RAN and the second RAN at the same time.

Clause 15: The method of Clause 14, wherein the one or more conditions comprise at least one of: one or more measurement-related conditions associated with the first RAN; or one or more user plane-related conditions associated with the first RAN.

Clause 16: The method of any one of Clauses 1-15, wherein the configuration information comprises one or more of: a data radio bearer configuration of the apparatus for the second RAN; a carrier aggregation configuration of the apparatus for the second RAN; or a measurement configuration of the apparatus for the second RAN.

Clause 17: A method for wireless communications by an apparatus comprising: receiving one or more indications of UE information comprising one or more of: UE control plane assistance information, for a UE, related to a first RAN, wherein the apparatus is associated with a second RAN; capability information of a capability of the UE to be connected to both the first RAN and the second RAN at a same time; or a measurement report comprising measurement information related to communications on the second RAN, wherein the measurement information is based on a measurement configuration obtained from the first RAN; obtaining configuration information associated with the second RAN; and communicating, based on the configuration information, with the second RAN.

Clause 18: The method of Clause 17, wherein the apparatus is associated with the second RAN.

Clause 19: The method of Clause 18, wherein the UE information comprises the capability information.

Clause 20: The method of Clause 18, wherein: the UE information comprises the UE control plane assistance information; and the UE control plane assistance information comprises one or more of: a RAN configuration of the UE for the first RAN; or one or more RAN capabilities of the UE for the first RAN.

Clause 21: The method of Clause 20, wherein: the UE control plane assistance information comprises the RAN configuration; and the RAN configuration comprises one or more of: a data radio bearer configuration of the UE for the first RAN; a carrier aggregation configuration of the UE for the first RAN; or the measurement configuration.

Clause 22: The method of Clause 18, wherein the UE information comprises the measurement report.

Clause 23: The method of any one of Clauses 17-22, wherein: the apparatus is associated with the first RAN; and the UE information comprises the measurement report.

Clause 24: The method of Clause 23, wherein the configuration information comprises: a connection establishment indication to connect to the second RAN.

Clause 25: The method of Clause 23, wherein the configuration information comprises: one or more suggested data sessions to move from the first RAN to the second RAN; or one or more suggested candidate cells of the second RAN.

Clause 26: The method of any one of Clauses 17-25, further comprising: sending an indication that the UE is not allowed to be connected to both the first RAN and the second RAN at the same time.

Clause 27: The method of Clause 26, wherein sending the indication comprises sending the indication in one or more of a system information message or a dedicated radio resource control message.

Clause 28: The method of Clause 26, wherein sending the indication comprises sending the indication as part of a policy configuration.

Clause 29: The method of any one of Clauses 17-28, further comprising: sending an indication of one or more conditions to satisfy for the UE to be allowed to be connected to both the first RAN and the second RAN at the same time.

Clause 30: The method of Clause 29, wherein the one or more conditions comprise at least one of: one or more measurement-related conditions associated with the first RAN; or one or more user plane-related conditions associated with the first RAN.

Clause 31: The method of any one of Clauses 17-30, wherein the configuration information comprises one or more of: a data radio bearer configuration of the UE for the second RAN; a carrier aggregation configuration of the UE for the second RAN; or a measurement configuration of the UE for the second RAN.

Clause 32: One or more apparatuses, comprising: one or more memories comprising executable instructions; and one or more processors configured to execute the executable instructions and cause the one or more apparatuses to perform a method in accordance with any one of Clauses 1-31.

Clause 33: One or more apparatuses, comprising: one or more memories; and one or more processors, coupled to the one or more memories, configured to cause the one or more apparatuses to perform a method in accordance with any one of Clauses 1-31.

Clause 34: One or more apparatuses, comprising: one or more memories; and one or more processors, coupled to the one or more memories, configured to perform a method in accordance with any one of Clauses 1-31.

Clause 35: One or more apparatuses, comprising means for performing a method in accordance with any one of Clauses 1-31.

Clause 36: One or more non-transitory computer-readable media comprising executable instructions that, when executed by one or more processors of one or more apparatuses, cause the one or more apparatuses to perform a method in accordance with any one of Clauses 1-31.

Clause 37: One or more computer program products embodied on one or more computer-readable storage media comprising code for performing a method in accordance with any one of Clauses 1-31.

Clause 38: A UE, comprising: a processing system that includes processor circuitry and memory circuitry that stores code and is coupled with the processor circuitry, the processing system configured to cause the UE to perform a method in accordance with any one of Clauses 1-16.

Clause 39: A network entity, comprising: a processing system that includes processor circuitry and memory circuitry that stores code and is coupled with the processor circuitry, the processing system configured to cause the network entity to perform a method in accordance with any one of Clauses 17-31.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means having the capability of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors, coupled to the one or more memories, configured to cause the apparatus to:
send one or more indications of apparatus information comprising one or more of:
user equipment (UE) control plane assistance information, of the apparatus, related to a first radio access network (RAN), wherein the UE control plane assistance information is sent to a second RAN;
capability information of a capability of the apparatus to be connected to both the first RAN and the second RAN at a same time; or
a measurement report comprising measurement information related to communications on the second RAN, wherein the measurement information is based on a measurement configuration obtained from the first RAN;
obtain configuration information associated with the second RAN; and
communicate, based on the configuration information, with the second RAN.

2. The apparatus of claim 1, wherein to send the one or more indications comprises to send the one or more indications to the second RAN.

3. The apparatus of claim 2, wherein the apparatus information comprises the capability information.

4. The apparatus of claim 2, wherein:
the apparatus information comprises the UE control plane assistance information; and
the UE control plane assistance information comprises one or more of:
a RAN configuration of the apparatus for the first RAN; or
one or more RAN capabilities of the apparatus for the first RAN.

5. The apparatus of claim 4, wherein:
the UE control plane assistance information comprises the RAN configuration; and
the RAN configuration comprises one or more of:
a data radio bearer configuration of the apparatus for the first RAN;
a carrier aggregation configuration of the apparatus for the first RAN; or
the measurement configuration.

6. The apparatus of claim 2, wherein the apparatus information comprises the measurement report.

7. The apparatus of claim 1, wherein:
to send the one or more indications comprises to send the one or more indications to the first RAN; and
the apparatus information comprises the measurement report.

8. The apparatus of claim 7, wherein the configuration information comprises:
a connection establishment indication to connect to the second RAN.

9. The apparatus of claim 7, wherein the configuration information comprises:
one or more suggested data sessions to move from the first RAN to the second RAN; or
one or more suggested candidate cells of the second RAN.

10. The apparatus of claim 1, wherein the one or more processors are configured to cause the apparatus to:
obtain an indication that the apparatus is not allowed to be connected to both the first RAN and the second RAN at the same time.

11. The apparatus of claim 10, wherein to obtain the indication comprises to obtain the indication in one or more of a system information message or a dedicated radio resource control message.

12. The apparatus of claim 10, wherein to obtain the indication comprises to obtain the indication as part of a policy configuration.

13. The apparatus of claim 10, wherein to obtain the indication comprises to obtain the indication from a core network (CN) policy management node.

14. The apparatus of claim 1, wherein the one or more processors are configured to cause the apparatus to:
obtain an indication of one or more conditions to satisfy for the apparatus to be allowed to be connected to both the first RAN and the second RAN at the same time.

15. The apparatus of claim 14, wherein the one or more conditions comprise at least one of:
one or more measurement-related conditions associated with the first RAN; or
one or more user plane-related conditions associated with the first RAN.

16. The apparatus of claim 1, wherein the configuration information comprises one or more of:
a data radio bearer configuration of the apparatus for the second RAN;
a carrier aggregation configuration of the apparatus for the second RAN; or
a measurement configuration of the apparatus for the second RAN.

17. A method for wireless communications by an apparatus, comprising:
sending one or more indications of apparatus information comprising one or more of:
user equipment (UE) control plane assistance information, of the apparatus, related to a first radio access network (RAN), wherein the UE control plane assistance information is sent to a second RAN;
capability information of a capability of the apparatus to be connected to both the first RAN and the second RAN at a same time; or
a measurement report comprising measurement information related to communications on the second RAN, wherein the measurement information is based on a measurement configuration obtained from the first RAN;
obtaining configuration information associated with the second RAN; and
communicating, based on the configuration information, with the second RAN.

18. The method of claim 17, wherein sending the one or more indications comprises sending the one or more indications to the second RAN.

19. The method of claim 18, wherein the apparatus information comprises the capability information.

20. One or more non-transitory computer-readable media comprising executable instructions that, when executed by one or more processors of an apparatus, cause the apparatus to perform operations comprising:
sending one or more indications of apparatus information comprising one or more of:
user equipment (UE) control plane assistance information, of the apparatus, related to a first radio access network (RAN), wherein the UE control plane assistance information is sent to a second RAN;
capability information of a capability of the apparatus to be connected to both the first RAN and the second RAN at a same time; or
a measurement report comprising measurement information related to communications on the second RAN, wherein the measurement information is based on a measurement configuration obtained from the first RAN;
obtaining configuration information associated with the second RAN; and
communicating, based on the configuration information, with the second RAN.
